(19) United States
(12) Patent Application Publication
(10) Pub. No.: US 2025/0367534 A1
(43) Pub. Date: Dec. 4, 2025

(54) SNOW SLIDING BOARD COMPRISING ONE OR MORE FUNCTIONAL LAYERS

(71) Applicant: Völkl Sports GmbH, Straubing (DE)

(72) Inventor: Tobias Heil, Bogen (DE)

(73) Assignee: Völkl Sports GmbH, Straubing (DE)

(21) Appl. No.: 18/963,949

(22) Filed: Nov. 29, 2024

(30) Foreign Application Priority Data
May 28, 2024 (DE) 202024102779.5

(51) Int. Cl. A63C 5/056; B32B 3/14; B32B 5/02; B32B 7/09; B32B 27/12

(52) U.S. Cl. CPC A63C 5/056; B32B 3/14; B32B 5/02; B32B 7/09; B32B 27/12; B32B 2262/06; B32B 2262/106; B32B 2307/54; B32B 2307/7376

(57) ABSTRACT

A snow sliding board includes multiple material layers arranged one above the other, including a substrate layer and a polymeric covering layer material, for example a synthetic resin, which covers the substrate layer on an upper side and forms a free surface on an upper side of the snow sliding board; and a strand geometry having one or more strands of strand material. The respective strand is fixedly connected to the substrate layer in order to form a composite layer and extends above the substrate layer, and the respective strand is raised protruding upwards and can be optically and haptically perceived as a raised structure on the upper side of the snow sliding board.

### CROSS REFERENCE TO RELATED APPLICATIONS

This claims priority to German Patent Application No. 20 2024 102 779.5, filed May 28, 2024, the contents of such application being incorporated by reference herein.

### FIELD OF THE INVENTION

The invention relates to a snow sliding board for downhill skiing and optionally also for touring in alpine terrain. The snow sliding board can for example be a snowboard or in particular an alpine ski, including freeride skis and touring skis suitable for downhill skiing. The snow sliding board comprises a layered composite comprising a sliding layer on a lower side, an upper covering layer on an upper side and at least one functional layer arranged between the sliding layer and the upper covering layer. The at least one functional layer can be a multi-part core, in particular a multi-part wooden core, or a substrate layer reinforced with strand material which is covered at least in regions by the upper covering layer on the upper side of the snow sliding board.

### BACKGROUND OF THE INVENTION

The skiing characteristics of snow sliding boards having a layered design can be set in a targeted way by configuring their material layers. US 2020/0282291 A1, incorporated herein by reference, proposes a substrate layer which is fiber-reinforced in a customized way in order to set a desired flexural and/or torsional stiffness, while EP 1 952 854 A1, incorporated herein by reference, discloses a core comprising a front and a rear longitudinal slot.

### SUMMARY OF THE INVENTION

An aspect of the invention aims to improve the skiing characteristics of snow sliding boards and for example to increase the dynamics and controllability while still maintaining a smooth skiing experience.

Another aspect can be regarded as being that of increasing flexibility in relation to setting skiing characteristics of snow sliding boards in order to be able to tailor the longitudinal flexural stiffness and/or torsional stiffness and/or the damping characteristics of a snow sliding board to each other in a targeted way during its manufacture.

An aspect of the invention relates to a snow sliding board comprising multiple material layers arranged one above the other in a layered composite, including a substrate layer and a polymeric covering layer material, for example a synthetic resin, which covers the substrate layer on an upper side of the layer and forms a free surface, which is therefore visible in a plan view, on an upper side of the snow sliding board. One or more strands of strand material is/are fixedly connected to the substrate layer. The connection is fixed in the sense that it is not released by the forces and moments which are to be expected during downhill skiing, and a strand geometry formed by the one or more strands absorbs and distributes the forces and moments and advantageously damps them. The substrate layer and the one or more strands which are advantageously fixed to the substrate layer together form a functional layer in the form of a composite layer which serves to reinforce the snow sliding board and/or to damp impacts and/or vibrations. The substrate layer can be a metal or plastic film or advantageously a textile fabric, for example a woven fabric, a knitted fabric or a fleece.

The one or more strands extend above the substrate layer. This includes embodiments in which the respective strand extends above the substrate layer over its entire length, as well as embodiments in which the respective strand only extends above the substrate layer in one or more sub-portions of its length and dips below the substrate layer in one or more other sub-portions. If multiple strands are provided, mixed forms can also be realized in which one or more strands extend above the substrate layer over the entire length of the respective strand, while one or more other strands only extend above the substrate layer in one or more sub-portions of the length of the respective strand. The one or more strands is/are arranged into a strand geometry which advantageously distributes forces and moments acting on the snow sliding board during skiing, in particular cornering, and thereby helps to set the flexural and/or torsional stiffness in the region of the strand geometry as desired.

A preform, for example a preform impregnated with synthetic resin, can in particular be used for the composite layer. The composite layer, i.e. the substrate layer together with the one or more strands connected to it for the purpose of reinforcing and/or damping, can advantageously be manufactured by means of Tailored Fiber Placement (TFP) technology, a laying and stitching method. The advantage of TFP technology is the ability to deposit, in a defined way, the one or more strands, such as a fiber roving, in a way which is variably axial in a plan view, i.e. having a freely selectable direction independent of location. This enables the composite layer exhibiting a variably axial strand profile to be optimally adapted to the desired skiing characteristics. The respective strand of the composite layer can be fixed to the substrate layer with the aid of a stitching thread.

With regard to the strand profile and the strand material, reference may be made to US 2020/0282291 A1, which is hereby incorporated by reference with respect to advantageous features of the arrangement and alignment of the one or more strands of the strand design as well as with respect to the strand material and strand structure.

In a first aspect of the invention, the respective strand of the composite layer is raised protruding upwards and can be optically and haptically perceived as a raised structure on the upper side of the snow sliding board, wherein the respective strand can be raised protruding upwards over its entire length or only in one or more sub-portions of its length.

In known snow sliding boards comprising a composite layer on the upper side of the respective snow sliding board, the strands of the composite layer are pressed into the layered structure of the snow sliding board, such that the layered structure exhibits a free surface which is at least substantially continuously smooth on its upper side. The one or more strands cannot be felt, i.e. haptically identified, when brushing over the surface. The snow sliding board in accordance with an aspect of the invention is likewise molded in a molding tool from material layers lying one above the other by means of applying positive and/or negative pressure, but the respective strand (if it is to be raised, protruding, in the finished snow sliding board) is not pressed into the layered composite or is pressed to a significantly lesser extent than previously. The strand or strand portion which is raised, protruding, is correspondingly also not pressed flat or otherwise substantially deformed or displaced relative to its original position, but rather still at least substantially exhibits its original cross-sectional shape as well as its intended position relative to the substrate layer in the snow sliding board.

The snow sliding board comprises: a front sliding board portion which comprises a front end of the snow sliding board; a rear sliding board portion which comprises a rear end of the snow sliding board; and a binding portion, which extends in a longitudinal direction from the front sliding board portion up to the rear sliding board portion in a plan view onto the snow sliding board, for arranging a sliding board binding. The composite layer can extend in the rear sliding board portion, for example only in the rear sliding board portion, or in particular in the front sliding board portion, for example only in the front sliding board portion. If the functional layer is provided in the front sliding board portion, another composite layer of the type in accordance with an aspect of the invention can be provided in the rear sliding board portion. A composite layer of the type in accordance with an aspect of the invention which is arranged in the front sliding board portion can extend from the front sliding board portion up to and into the binding portion. Alternatively or additionally, a composite layer of the type in accordance with an aspect of the invention which is arranged in the rear sliding board portion can extend from the rear sliding board portion up to and into the binding portion.

The composite layer can comprise one or more additional strands, wherein the respective additional strand is likewise fixedly connected to the substrate layer in the sense already mentioned above, but extends only below the substrate layer or at least is not raised protruding upwards over its entire length.

The upper covering layer can be translucent or in particular transparent, such that the strand geometry can be optically identified not only because it protrudes, but also in relation to its color and/or strand structure. In such embodiments, an additional strand or strand portion which is optionally not raised and for example located below the substrate layer can also be visible. This also enables any errors in the strand geometry to be determined in a simple way by visual testing, for example within the framework of an inspection or quality control.

If the respective strand exhibits a thickness D as measured in a vertical direction of the snow sliding board, and the snow sliding board exhibits peaks of height w on its upper side because of the strands which are raised protruding upwards, then in advantageous embodiments, the relation w>0.3×D or w>0.5×D holds with regard to the degree to which the respective strand is raised. Alternatively or additionally, at least one of the relations d>0.3×D, d≥0.5×D and d>0.7×D can hold, wherein d is the degree of protrusion measured in the vertical direction of the snow sliding board as compared to the strand-free region of the substrate layer which laterally adjoins the respective strand.

It is advantageous if at least a lower cross-sectional region of the respective strand is embedded, at least in portions, in the polymeric covering layer material. This more firmly fixes the strand in its intended position. It is even more advantageous if the polymeric covering layer material also covers the respective strand on the latter's upper side. In such embodiments, the enveloping covering layer can even more firmly fix the strand and/or protect the strand from external influences in the cross-sectional region protruding upwards. The respective strand can be embedded in the polymeric covering layer material over its entire circumference.

If the composite layer is formed from a preform impregnated with synthetic resin, the resin can wet the respective strand of the composite layer. In alternative embodiments, a “dry” preform can be used and impregnated with the covering layer material in the molding tool, such that it immediately wets the respective strand.

The composite layer can exhibit one or more crossing points at which multiple strands cross in a plan view onto the upper side of the snow sliding board. If the strand geometry of the composite layer is formed by one strand only, the latter can be laid in one or more loops and cross itself, i.e. form one or more crossing points with itself. A mixed form can equally be implemented in which a first strand extends in one or more loops and crosses itself and/or a second strand which is not laid in loops or which extends in loops but does not cross itself. The one or more strands can be raised protruding upwards, in particular in the region of one or more crossing points. In conventional embodiments, it is precisely the crossing points at which there is a risk of strand portions being permanently deformed and/or displaced relative to the substrate layer and/or relative to each other and a risk of the actual strand geometry deviating from the intended geometry.

The strand material is not limited to particular classes of material. It can be a plastic material, a ceramic material including glass, a mineral or natural organic material or a metal material. The respective strand can contain and preferably consist of plastic fibers and/or filaments and/or mineral fibers and/or filaments and/or natural fibers and/or filaments or a combination of such fibers and/or filaments. The respective strand can in particular be a roving or yarn or rope. In principle, however, the respective strand can also be a metal wire. The respective strand can be formed from fibers and/or filaments of only the same material or instead from fibers and/or filaments of different materials.

If the composite layer comprises multiple strands, the multiple strands can be the same or can be different in a way which is customized to the load situation and/or desired effect, for example absorbing loads and/or damping. In advantageous embodiments, multiple strands made of different materials are used. A first strand can then for example consist of a plastic material, and a second strand can consist of a natural organic material. The composite layer can comprise one or more first strands made of a first material, for example carbon fibers and/or filaments or flax or hemp fibers and/or filaments, and one or more other, second strands made of a different, second material, for example natural fibers and/or filaments. A combination of carbon fibers and/or filaments and natural fibers and/or filaments is particularly advantageous. While the carbon fibers ensure maximum transmission of force, the natural fibers are responsible for smooth handling with optimum damping. In modifications, the carbon fibers and/or filaments can be replaced with hemp fibers and/or filaments and/or with flax fibers and/or filaments which can likewise absorb forces to a sufficient extent. One or more strands of carbon fibers and/or filaments and/or flax fibers and/or filaments and/or hemp fibers and/or filaments can advantageously be arranged along one or more lines of force of the snow sliding board, in particular in the front sliding board portion, specifically its paddle region, in order to improve the dynamics of the snow sliding board and reduce the effort required of the skier.

An aspect of the invention also includes a snow sliding board comprising: a front sliding board portion which comprises a front end of the snow sliding board; a rear sliding board portion which comprises a rear end of the snow sliding board; and a binding portion which extends in the longitudinal direction of travel between the rear sliding board portion and the front sliding board portion in a plan view onto the snow sliding board and serves to arrange a sliding board binding. The binding portion extends up to the front sliding board portion and up to the rear sliding board portion. The snow sliding board comprises a sliding layer on a lower side and an upper covering layer on an upper side. In a second aspect of the invention, such a snow sliding board comprises a multi-part core, comprising a left-hand core profile and a right-hand core profile, as a functional layer in accordance with an aspect of the invention between the sliding layer and the upper covering layer. The left-hand and right-hand core profiles extend alongside each other in the longitudinal direction through the binding portion into both the front sliding board portion and the rear sliding board portion. They can advantageously extend up to or near to the front end of the snow sliding board and/or up to or near to the rear end of the snow sliding board. In the front sliding board portion and/or in the rear sliding board portion, the left-hand and right-hand core profiles exhibit a distance from each other, as measured transversely to the longitudinal direction, which can advantageously vary over the longitudinal extent of the core profiles.

A front intermediate space remains between the core profiles in the front sliding board portion, and/or a rear intermediate space remains between the core profiles in the rear sliding board portion. In first variants, the front intermediate space and/or the rear intermediate space is/are devoid of material. In second variants, the front intermediate space and/or the rear intermediate space is/are at least partially filled with a material which spans the respective intermediate space and restricts the ability of the core profiles to move relative to each other. The joining material and the material situated in the respective intermediate space advantageously differ from each other in terms of their composition and/or structure. In the second variants, it is advantageous if the joining material has a greater Shore hardness than the material which spans the respective intermediate space.

In developments, the left-hand and right-hand core profiles exhibit over their entire longitudinal extent a distance from each other, as measured transversely to the longitudinal direction, which can vary over the longitudinal extent of the core profiles.

In advantageous embodiments, a joining structure made of a joining material extends between the core profiles. The joining structure can for example be a molded body which is original-molding from the joining material. The joining structure is joined to the core profiles and fixedly connects the core profiles to form a joined core in the binding portion. The connection is fixed in the sense that it is not released by the forces and moments which are to be expected during downhill skiing. The joining structure is arranged between inner sides of the core profiles which face each other in the transverse direction and advantageously terminates at the front sliding board portion and/or at the rear sliding board portion.

The snow sliding board can exhibit one or more of the features disclosed in the first aspect in combination with one or more of the features disclosed in the second aspect. The strand geometry enables the transmission and distribution of forces to be optimized and enables the damping and therefore reducing of vibrations to be improved. A longitudinally divided core helps to increase the dynamics and improve control. Each of the two aspects, and combining them even more so, can help to reduce the weight of the snow sliding board.

If the first and second aspects are implemented in combination, the strand geometry can advantageously span the intermediate space between the left-hand core profile and the right-hand core profile in a plan view onto the composite layer, preferably overlapping both core profiles, in order to couple the core profiles which are spaced apart from each other in the transverse direction in the respective sliding board portion. The strand geometry can then comprise one or more strands or strand portions for transmitting transverse forces and/or longitudinal forces. The respective strand or strand portion can be arranged such that it transmits transverse forces and/or longitudinal forces between the core profiles and/or longitudinal forces between the binding portion and one of the core profiles and/or between longitudinally spaced points on the same core profile across the respective intermediate space. The strand geometry can damp relative movements of the core profiles within the framework of coupling, in particular in embodiments in which the strand geometry comprises one or more strands made of natural fibers and/or filaments.

Features of aspects of the invention are also described in the aspects formulated below. The aspects are formulated in the manner of claims and can substitute for them. Features disclosed in the aspects can also supplement and/or qualify the claims, indicate alternatives with respect to individual features and/or broaden the claim features. Bracketed reference signs refer to example embodiments of the invention illustrated below in figures. They do not restrict the features described in the aspects to their literal sense as such, but do conversely indicate preferred ways of implementing the respective feature.

1. A snow sliding board comprising:
(a) multiple material layers (4-9) arranged one above the other, including a substrate layer (8) and a polymeric covering layer material (9), for example a synthetic resin, which covers the substrate layer (8) on an upper side and forms a free surface on an upper side (U) of the snow sliding board; and
(b) a strand geometry comprising one or more strands (11, 12) of strand material,
(c) wherein the respective strand (11, 12) is fixedly connected to the substrate layer (8) and preferably fixed to the substrate layer (8) at multiple points.

2. The snow sliding board according to the preceding aspect, wherein the respective strand (11, 12) is raised protruding upwards and can be optically and haptically perceived as a raised structure on the upper side of the snow sliding board.

3. The snow sliding board according to any one of the preceding aspects, wherein the respective strand (11, 12) extends above the substrate layer (8).

4. The snow sliding board according to any one of the preceding aspects, wherein the respective strand (11, 12) exhibits a thickness (D) as measured in a vertical direction (Z) of the snow sliding board and produces a peak of height (w) on the upper side (U) of the snow sliding board, and wherein w>0.3×D or w≥0.5×D.

5. The snow sliding board according to any one of the preceding aspects, wherein the respective strand (11, 12) exhibits a thickness (D) as measured in a vertical direction (Z) of the snow sliding board and is raised protruding upwards beyond the substrate layer (8) by a degree of protrusion (d), and wherein d>0.3×D or d≥0.5×D or d≥0.7×D.

6. The snow sliding board according to any one of the preceding aspects, wherein the respective strand (11, 12) is connected to the substrate layer (8) by means of a laying and stitching (TFP) method.

7. The snow sliding board according to any one of the preceding aspects, wherein the respective strand (11, 12) is locally fixed to the substrate layer (8) at multiple points, preferably by means of a thread.

8. The snow sliding board according to any one of the preceding aspects, wherein at least a lower cross-sectional region of the respective strand (11, 12), preferably the respective strand (11, 12) as a whole, is embedded, at least in portions, in the polymeric covering layer material (9).

9. The snow sliding board according to any one of the preceding aspects, wherein the polymeric covering layer material (9) covers the respective strand (11, 12) on the latter's upper side.

10. The snow sliding board according to any one of the preceding aspects, wherein the polymeric covering layer material (9) covers the respective strand (11, 12) at least in portions, such that the free surface formed by the covering layer material (9) is undulating, at least in regions, in cross-sections and/or longitudinal sections of the snow sliding board.

11. The snow sliding board according to any one of the preceding aspects, wherein the covering layer material (9) covers the respective strand (11, 12) at least in portions, and a thickness of the polymeric covering layer material (9) on an upper side of the respective strand (11, 12) is smaller than in a region of the covering layer material (9) next to the respective strand (11, 12).

12. The snow sliding board according to any one of the preceding aspects, wherein the strand geometry exhibits one or more crossing points at which the one or more strands (11, 12) cross in a plan view onto the upper side (U) of the snow sliding board.

13. The snow sliding board according to any one of the preceding aspects, wherein the composite layer (8, 9, 11, 12) extends in a front sliding board portion (1), advantageously in a paddle region of a ski.

14. The snow sliding board according to the preceding aspect, wherein another composite layer extends in a rear sliding board portion (3).

15. The snow sliding board according to the preceding aspect, wherein said other composite layer corresponds to any one of aspects 1 to 12.

16. The snow sliding board according to any one of aspects 1 to 12, wherein the composite layer (8, 9, 11, 12) extends in the rear sliding board portion (3).

17. The snow sliding board according to the preceding aspect, wherein another composite layer extends in the front sliding board portion (1).

18. The snow sliding board according to the preceding aspect, wherein said other composite layer corresponds to any one of aspects 1 to 12.

19. The snow sliding board according to any one of the preceding aspects, wherein the composite layer (8, 9, 11, 12) extends counter to the longitudinal direction (X) in the front sliding board portion (1) or in the longitudinal direction (X) in the rear sliding board portion (3) up to at most the binding portion (2).

20. The snow sliding board according to any one of aspects 1 to 18, wherein the composite layer (8, 9, 11, 12) extends counter to the longitudinal direction (X) from the front sliding board portion (1) up to and into the binding portion (2) or rear sliding board portion (3), wherein the respective strand (11, 12) is preferably pressed in and/or pressed flat in the binding portion (2), such that the binding portion (2) exhibits an at least substantially non-undulating surface on the upper side (U).

21. The snow sliding board according to any one of the preceding aspects in combination with any one of aspects 14 and 17, respectively, wherein said other composite layer (8, 9, 11, 12) extends counter to the longitudinal direction (X) in the front sliding board portion (1) or in the longitudinal direction (X) in the rear sliding board portion (3) up to at most the binding portion (2).

22. The snow sliding board according to any one of aspects 1 to 20, in combination with any one of aspects 14 and 17, respectively, wherein said other composite layer (8, 9, 11, 12) extends in the longitudinal direction (X) from the rear sliding board portion (3) up to and into the binding portion (2) or front sliding board portion (1), wherein the respective strand (11, 12) is preferably pressed in and/or pressed flat in the binding portion (2), such that the binding portion (2) exhibits an at least substantially non-undulating surface on the upper side (U).

23. The snow sliding board according to any one of the preceding aspects, wherein the polymeric covering layer material (9) is a synthetic resin.

24. The snow sliding board according to any one of the preceding aspects, wherein the substrate layer (8) is a textile fabric.

25. The snow sliding board according to any one of the preceding aspects, wherein the substrate layer (8) is a knitted fabric, for example a warp-knitted fabric, or a woven fabric, scrim or fleece.

26. The snow sliding board according to any one of the preceding aspects, wherein the respective strand (11, 12) is a roving or yarn or rope made of plastic fibers and/or filaments and/or ceramic fibers and/or filaments and/or mineral fibers and/or filaments and/or natural fibers and/or filaments.

27. The snow sliding board according to any one of the preceding aspects, wherein the respective strand (11, 12) is a roving or yarn or rope made of carbon fibers and/or filaments and/or bast fibers and/or filaments, for example flax fibers and/or filaments.

28. The snow sliding board according to any one of the preceding aspects, wherein the strand structure (10) comprises one or more first strands (11) made of a first material, for example carbon fibers and/or filaments and/or flax fibers and/or filaments, and one or more other, second strands (12) made of a different, second material, for example natural fibers and/or filaments.

29. The snow sliding board according to any one of the preceding aspects, wherein
the strand structure (10) comprises a first strand (11) and a second strand (12),
the first strand (11) and/or the second strand (12) extend(s) above the substrate layer (8) at least in portions and is/are fixedly connected to the substrate layer (8),
the first strand (11) and/or the second strand (12) is/are raised protruding upwards at least in portions, such that the first strand (11) and/or the second strand (12) can (each) be optically and haptically perceived as a raised structure on the upper side (U) of the snow sliding board.

30. The snow sliding board according to the preceding aspect, wherein the first strand (11) exhibits a different cross-section as measured in the vertical direction (Z) of the snow sliding board, for example a different thickness as measured in the vertical direction (Z) and/or a different outer contour and/or a different cross-sectional area, than the second strand (12).

31. The snow sliding board according to any one of the immediately preceding two aspects, wherein the first strand (11) crosses the second strand (12).

32. The snow sliding board according to any one of the immediately preceding three aspects, wherein the first strand (11) and/or the second strand (12) extends or each extend in one or more loops.

33. The snow sliding board according to the preceding aspect, wherein the first strand (11) and/or the second strand (12) crosses itself.

34. The snow sliding board according to any one of the immediately preceding five aspects, wherein the second strand (12) has a greater tensile strength than the first strand (11).

35. The snow sliding board according to any one of the immediately preceding six aspects, wherein the first strand (11) comprises natural fibers and/or filaments, for example made of flax or hemp or sisal or kenaf, and the second strand (12) comprises carbon fibers and/or filaments.

36. The snow sliding board according to any one of the preceding aspects, wherein the snow sliding board comprises multiple first strands (11) and/or multiple second strands (12).

37. A snow sliding board comprising:
(a) a front sliding board portion (1) which comprises a front end of the snow sliding board, a rear sliding board portion (3) which comprises a rear end of the snow sliding board, and a binding portion (2) which extends in a longitudinal direction (X) from the rear sliding board portion (3) up to the front sliding board portion (1) in a plan view onto the snow sliding board, for arranging a sliding board binding;
(b) a sliding layer (4) on a lower side of the snow sliding board; and
(c) a multi-part core (6) arranged between the sliding layer (4) and the upper covering layer (9) and comprising a left-hand core profile (13) and a right-hand core profile (14) which extend in the longitudinal direction (X) through the binding portion (2) into the front sliding board portion (1) and into the rear sliding board portion (3) and exhibit a distance (A) from each other as measured in the transverse direction (Y), at least in the front sliding board portion (1) and/or in the rear sliding board portion (3).

38. The snow sliding board according to the preceding aspect, comprising a joining structure (15) made of a joining material which extends between the core profiles (13, 14), is joined to the core profiles (13, 14) and fixedly connects the core profiles (13, 14) in the binding portion (2).

39. The snow sliding board according to the preceding aspect, wherein the joining structure (15) is arranged between inner sides of the core profiles (13, 14) which face each other in the transverse direction (Y).

40. The snow sliding board according to any one of the immediately preceding two aspects, wherein the joining structure (15) terminates at the front sliding board portion (1) and at the rear sliding board portion (3).

41. The snow sliding board according to any one of aspects 37 to 40, wherein a front intermediate space (17) which is devoid of material or is at least partially filled with a material which differs from the joining material in terms of its composition and/or structure remains between the core profiles (13, 14) in the front sliding board portion (1).

42. The snow sliding board according to any one of aspects 37 to 41, wherein a front intermediate space (17) remains between the core profiles (13, 14) in the front sliding board portion (1), and the joining material has a greater Shore hardness than a material which spans the front intermediate space (17).

43. The snow sliding board according to any one of aspects 37 to 42, wherein a rear intermediate space (18) which is devoid of material or is at least partially filled with a material which differs from the joining material in terms of its composition and/or structure remains between the core profiles (13, 14) in the rear sliding board portion (3).

44. The snow sliding board according to any one of aspects 37 to 43, wherein a rear intermediate space (18) remains between the core profiles (13, 14) in the rear sliding board portion (3), and the joining material has a greater Shore hardness than a material which spans the rear intermediate space (18).

45. The snow sliding board according to any one of aspects 37 to 44, wherein the distance (A) between the core profiles (13, 14) as measured in the transverse direction (Y) varies in the longitudinal direction (X) and increases from the joining structure (15) towards the front end and/or towards the rear end and is preferably at its smallest over the length of the joining structure (15).

46. The snow sliding board according to any one of aspects 37 to 45, wherein the distance (A) between the core profiles (13, 14) as measured in the transverse direction (Y) is constant over the length of the joining structure (15).

47. The snow sliding board according to any one of aspects 37 to 46, wherein the core profiles (13, 14) have a thickness (H) as measured in the vertical direction (Z) which varies in the longitudinal direction (X).

48. The snow sliding board according to any one of aspects 37 to 47, wherein the core profiles (13, 14) exhibit a maximum thickness (H) in the binding portion (2), and the thickness (H) decreases towards the front end and/or towards the rear end.

49. The snow sliding board according to any one of aspects 37 to 48, wherein the core profiles (13, 14) are joined to the joining structure (15) in a core joining portion (2) and cannot be moved relative to each other over the length of the core joining portion (2), preferably over the length of the joining structure (15).

50. The snow sliding board according to any one of aspects 37 to 49, wherein the core profiles (13, 14) can be moved more relative to each other in the longitudinal direction (X) in front of and behind the joining structure (15) than in the core joining portion (2).

51. The snow sliding board according to any one of aspects 37 to 50, wherein the core profiles (13, 14) are wooden profiles, for example core profiles glued together from different types of wood.

52. The snow sliding board according to any one of aspects 37 to 51, wherein the joining material is an impact-resistant plastic having a Shore hardness in the Shore D range.

53. The snow sliding board according to any one of aspects 37 to 52, wherein the joining material is a plastic having a Shore hardness of H_{D}>50D or H_{D}>55D or H_{D}≥60D.

54. The snow sliding board according to any one of aspects 37 to 53, wherein the joining material is a thermoplastic, for example ABS.

55. The snow sliding board according to any one of aspects 37 to 54, comprising:
multiple material layers (4-9) arranged one above the other, including a substrate layer (8) and a polymeric covering layer material (9), for example a synthetic resin, which covers the substrate layer (8) on an upper side and forms a free surface on an upper side (U) of the snow sliding board; and
a strand geometry comprising one or more strands (11, 12) of strand material,
wherein the respective strand (11, 12) is fixedly connected to the substrate layer (8) and preferably fixed to the substrate layer (8) at multiple points.

56. The snow sliding board according to the preceding aspect, wherein the strand geometry (11, 12) couples the left-hand core profile (13) and the right-hand core profile (14) in relation to transverse forces and/or longitudinal forces.

57. The snow sliding board according to any one of the immediately preceding two aspects, wherein the strand geometry (11, 12) comprises one or more strands or strand portions (11) which spans or which each span a front intermediate space (17) which remains between the core profiles (13, 14) in the front sliding board portion (1) and/or a rear intermediate space (18) which remains between the core profiles (13, 14) in the rear sliding board portion (3).

58. The snow sliding board according to any one of the immediately preceding three aspects, wherein the respective strand (11, 12) extends above the substrate layer (8) and is raised protruding upwards and can be optically and haptically perceived as a raised structure on the upper side of the snow sliding board.

59. The snow sliding board according to any one of the immediately preceding four aspects, wherein the respective strand (11, 12) exhibits a thickness (D) as measured in a vertical direction (Z) of the snow sliding board and produces a peak of height (w) on the upper side (U) of the snow sliding board, and wherein w>0.3×D or w>0.5×D.

60. The snow sliding board according to any one of the immediately preceding five aspects, wherein the composite layer (8, 9, 11, 12) extends in the front sliding board portion (1), advantageously in a paddle region of a ski.

61. The snow sliding board according to any one of aspects 1 to 36 in combination with any one of aspects 37 to 60, respectively.

### BRIEF DESCRIPTION OF THE DRAWINGS

An example embodiment of the invention is described below on the basis of figures. Features disclosed by the example embodiment, each individually and in each combination of features, advantageously develop the subject matter of the claims and the above aspects as well as the other embodiments described above. There is shown:

FIG. 1 a snow sliding board comprising a composite layer in accordance with an aspect of the invention, in a plan view;

FIG. 2 the cross-section II-II in FIG. 1;

FIG. 3 the longitudinal section III-III in FIG. 1;

FIG. 4 a sub-region of a snow sliding board comprising a conventional composite layer, in a longitudinal section;

FIG. 5 a multi-part core of the snow sliding board, in a plan view;

FIG. 6 the cross-section VI-VI in FIG. 5;

FIG. 7 the cross-section VII-VII in FIG. 5; and

FIG. 8 the cross-section VIII-VIII in FIG. 5.

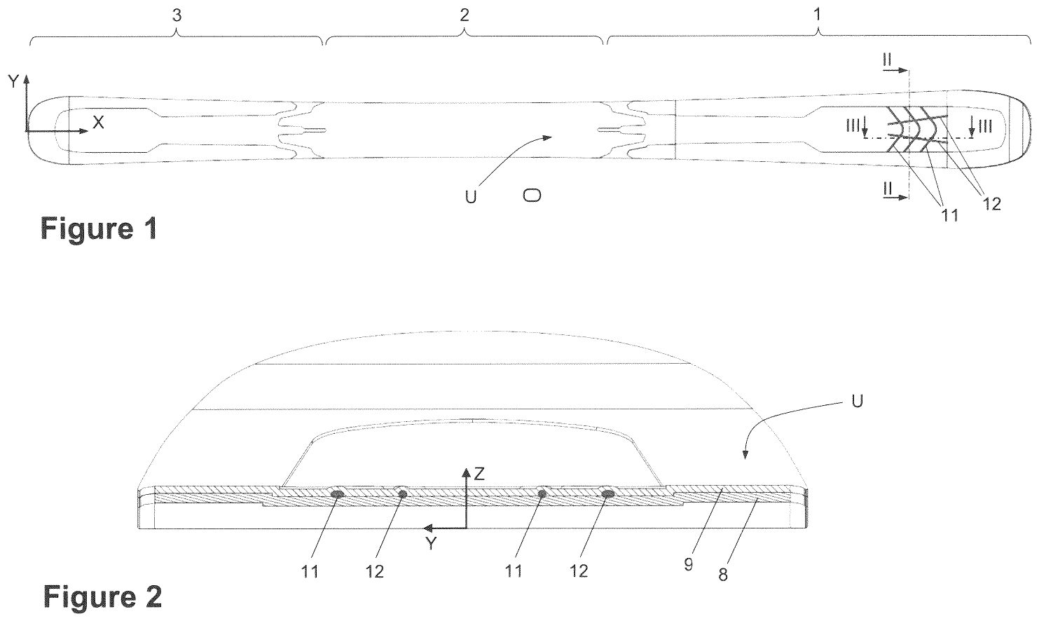

FIG. 1 shows a snow sliding board in a plan view onto an upper side U of the snow sliding board. For the purposes of the example embodiment, an alpine ski has been selected. The ski can be a downhill ski, a freeride ski or a touring ski, i.e. a ski which is suitable for downhill skiing in alpine terrain. Since an aspect of the invention also in principle offers advantages for snowboards, the ski in the example embodiment will continue to be referred to as a snow sliding board.

In relation to a longitudinal direction of travel X, the snow sliding board comprises a front sliding board portion 1, a rear sliding board portion 3 and a binding portion 2 between the sliding board portions 1 and 3 in the longitudinal direction X. A sliding board binding can be arranged in the binding portion 2. The binding portion 2 extends in the longitudinal direction X from the rear sliding board portion 3 up to the front sliding board portion 1. The front sliding board portion 1 extends from the binding portion 2 up to the front end of the snow sliding board. The rear sliding board portion 3 extends from the rear end of the snow sliding board up to the binding portion 2.

The snow sliding board is constructed from multiple material layers which are arranged one above the other in a vertical direction of the snow sliding board which points orthogonally to the plane of the plan view. At least one of these material layers is a composite layer which comprises a substrate layer and one or more strands of strand material which are fixedly connected to the substrate layer. The composite layer is arranged in the front sliding board portion 1, where it can in particular extend in the paddle region of the snow sliding board. In the example embodiment, the composite layer comprises one or more first strands 11 and one or more second strands 12 which cross with the one or more first strands 11 in the paddle region.

It is assumed for the purposes of the example embodiment that the composite layer comprises multiple first strands 11 and multiple second strands 12 which are each fixedly connected as separate strands to the substrate layer. In modifications, the composite layer can also comprise only one first strand 11 and/or one second strand 12, wherein the respective individual strand 11 and/or 12 extends in loops, such that the same strand geometry as in the example embodiment can be implemented using only one first strand 11 and/or only one second strand 12. In an extreme scenario, the strand geometry of the composite layer can be implemented using only one strand which extends in a correspondingly large number of loops and is fixedly connected to the substrate layer in accordance with the desired strand profile.

The strands 11 and 12 or as applicable the sole strand of the composite layer is/are expediently fixed to the substrate layer at multiple points in order to precisely predetermine the desired profile and therefore strand geometry. While, for the sake of linguistic simplicity, multiple first strands 11 and/or multiple second strands 12 are mentioned below, this is also intended to encompass example embodiments in which the respective composite layer comprises only one first strand 11 and/or only one second strand 12.

The first strands 11 extend substantially in a transverse direction Y which points transversely to the longitudinal direction X, while the second strands 12 extend substantially in the longitudinal direction X. By way of example, the first strands 11 form a “V” in the plan view, advantageously a flat “V” comprising a rounded portion in the region where the two limbs of the respective “V” converge. The rounded tip of the “V” points in the longitudinal direction X, as is preferred. In modifications, the respective tip can also point counter to the longitudinal direction of travel X. The first strands 11 extend at a flat inclination, i.e. at a small angle of inclination to the longitudinal direction X. The first strands 11 predominantly transmit the transverse forces, which act in the paddle region in particular during cornering, in accordance with their profile, but also help to a lesser extent to transmit longitudinal forces. The second strands 12 predominantly transmit the longitudinal forces, which act during cornering, in accordance with their profile, and only to a lesser extent the transverse forces which act during cornering. The first strands 11 and/or the second strands 12 are arranged along lines of force which have advantageously been calculated for a series of load scenarios such as can occur in particular during cornering, for example by means of a finite element method (FEM).

FIG. 2 shows the snow sliding board in a cross-section II-II which is indicated in FIG. 1 and extends in the transverse direction Y through the paddle region. Of the material layers arranged one above the other in the vertical direction Z, the substrate layer 8 (which forms part of the composite layer), the strands 11 and 12 and an upper covering layer 9 made of a polymeric covering layer material are highlighted. Other material layers situated beneath the substrate layer 8 are merely inferred. The covering layer 9 covers the substrate layer 8 as well as the strands 11 and 12 and forms an outer free surface of the snow sliding board on the upper side U of the snow sliding board.

Unlike conventional composite layers, the strands 11 and 12 each protrude upwards beyond the substrate layer 8 and can be identified optically and in particular also haptically as strands 11 and 12 which are raised upwards in the vertical direction Z. The covering layer 9 is undulating in accordance with the profile of the strands 11 and 12 which are raised protruding upwards.

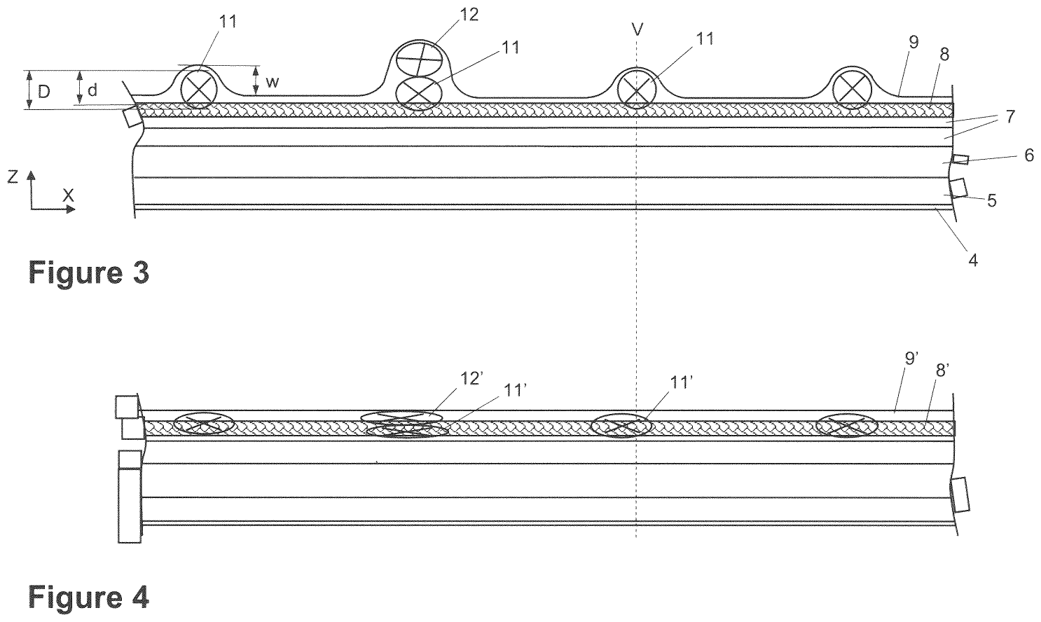

FIG. 3 shows the snow sliding board in the longitudinal section III-III which is likewise indicated in FIG. 1 and extends in the longitudinal direction X in the front sliding board portion 1 in the region of the composite layer. The layered structure of the snow sliding board, i.e. the material layers arranged one above the other, are shown schematically and only by way of example. The snow sliding board comprises a lower laminate 5 and an upper laminate 7 which for their part can be single-layered or multi-layered. The lower laminate 5 and/or the upper laminate 7 can (each) comprise one or more material layers which extend(s) over the entire length of the snow sliding board or at least near to the front end of the snow sliding board and/or near to the rear end of the snow sliding board. A core 6 is arranged between the lower laminate 5 and the upper laminate 7 in the vertical direction Z. The core 6 serves in particular to maintain a distance between the upper laminate 7 and the lower laminate 5 in the vertical direction Z. The core 6 can for example be a plastic core, such as a plastic core made of a polymeric foam material, or in particular a wooden core. A sliding layer 4 which extends beneath the lower laminate 5 forms a free outer sliding surface on the lower side of the sliding board. In particularly high-quality embodiments of the snow sliding board, the sliding layer can for example consist of sintered, ultra-high-molecular polyethylene having a very high density, for example P-Tex 4504, which ensures particular wear resistance and optimum wax absorption.

The composite layer, which is arranged above the upper laminate 7 in the front sliding board portion 1 and composed of the substrate layer 8 and the strand geometry which is fixedly connected to the substrate layer 8 and which in the example embodiment comprises the strands 11 and 12, can also be seen. The substrate layer 8 and the strand geometry 11, 12 are covered by a polymeric upper covering layer 9. The upper covering layer 9 forms a free outer surface or visible surface on the upper side of the snow sliding board. The upper covering layer 9 can be assigned to the composite layer. Due to its function of absorbing and distributing forces and moments, the composite layer can be regarded as a separate layer or as a material layer of the upper laminate 7.

The substrate layer 8 can in particular be a textile fabric, for example a woven fabric or a knitted fabric.

The strands 11 and 12 can advantageously each consist of a fiber material, preferably long fibers or continuous fibers, i.e. filaments. The fibers can extend parallel to each other or can be intertwined. Accordingly, the strands 11 and 12 can be rovings, yarns or rope-shaped strands 11 and 12. Carbon fibers and/or natural fibers, for example hemp fibers and/or flax fibers, are in particular suitable as fiber materials, wherein both short fibers and long fibers, i.e. filaments, are intended to be encompassed by the term “fiber”. A combination of carbon fibers and natural fibers, in particular bast fibers and of these in particular flax fibers, is particularly advantageous. The first strands 11 which extend substantially in the transverse direction Y can then for example consist of natural fibers, such as flax fibers, and the second strands 12 which extend substantially in the longitudinal direction X can consist of carbon fibers. While the carbon fibers ensure maximum transmission of force, the natural fibers are responsible for smooth handling with optimum damping.

One particular feature is that the strands 11 and 12 are not pressed into the substrate layer 8 or even into material layers below, or at least to a significantly lesser extent than with conventional snow sliding boards, but are instead raised protruding upwards, i.e. in the vertical direction Z, beyond the substrate layer 8 on the upper side of the snow sliding board, such that the strands 11 and 12 and therefore the strand geometry formed by the strands 11 and 12 can be optically as well as haptically identified. Because they are raised, the upper covering layer 9 which also covers the strands 11 and 12 on their upper side forms a free surface which undulates in accordance with the strand profile. The polymeric covering layer material can advantageously be translucent or in particular transparent, such that the strand geometry 11, 12 can be identified not only by its contour but also for example by its color.

In advantageous embodiments, at least a third or at least half of the strand thickness of the strands 11 and 12, as measured in the vertical direction Z, protrudes upwards beyond the substrate layer 8. If “D” denotes the thickness of the respectively non-deformed strand 11 and/or 12 in the vertical direction Z and “d” denotes the degree of protrusion of the respective strand, as measured in the vertical direction Z, as compared to the adjoining region of the substrate layer 8 after the snow sliding board has been molded in the molding tool, then d>0.3×D preferably holds. It is even more advantageous if d>0.5×D or d>0.7×D holds. Because the free surface undulates, the height “w” of the peaks can also be measured as a measure of the degree of protrusion, for which w>0.3×D or w>0.5×D can advantageously hold.

For comparison, FIG. 4 shows a layered structure comprising a conventionally embodied composite layer. The components of the comparative layer are denoted by the same numerals as in the example embodiment, wherein the numerals are followed by an apostrophe for the purpose of distinguishing them. For the purposes of comparison, it is assumed that a preform which is identical to the preform of the example embodiment is used to manufacture the comparative layer. The composite layer of the example embodiment and the comparative layer are therefore formed using identically designed preforms, such that the strands 11 and 12 on the one hand and the strands 11′ and 12′ on the other form the same strand geometry before processing and are fastened in the same way to the respective substrate layer 8 and 8′, preferably by means of the TFP technique.

In the comparative example, the strands 11′ and 12′ were pressed into the substrate layer 8′ and/or pressed together with the substrate layer 8′ into a material layer below during processing in the molding tool and were also inwardly deformed, in particular pressed flat, to a far greater extent than the strands 11 and 12 of the example embodiment. When manufacturing the snow sliding board in accordance with an aspect of the invention, by contrast, the molding which is performed in the molding tool is configured such that the strands 11 and 12 are not pressed towards the lower side into the substrate layer 8 or into material layers below, or only to a significantly lesser extent. Because comparatively little force is applied in the vertical direction Z, the strands 11 and 12 cannot be appreciably displaced from their positions as predetermined by fixing them to the substrate layer 8. The strands 11 and 12 remain practically true-to-position in their positions as predetermined by fixing them. The displacement is indicated in the example embodiment by a vertical straight line V representing the intended position. While the raised and protruding strand 11 of the example embodiment assumes the intended position even after the snow sliding board has been molded, the strand 11′ of the comparative example with which it is to be compared has been not only inwardly pressed flat, but also displaced sideways, in this case in the longitudinal direction X. Cross-sectional deformations and lateral displacements in the longitudinal direction X and/or transverse direction Y are in particular a danger in the region of crossing points. The cross-sectional deformations and/or lateral displacements lead to deviations from the intended profile of the strands 11′ and 12′ and therefore to deviations from the desired profile of the lines of force. In addition, the cross-sections of the strands 11 and 12 are not deformed or are deformed to a significantly lesser extent than in the comparative example.

The core 6 can comprise one part or advantageously multiple parts. The core 6 can in particular comprise two parts, as is the case in the example embodiment.

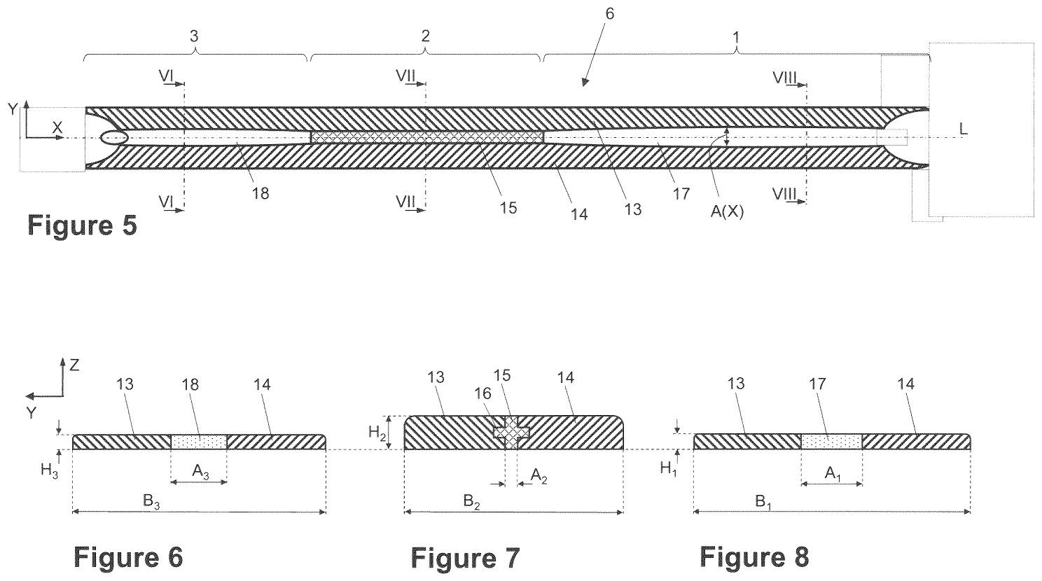

FIG. 5 shows the two-part core 6 on its own, separated from the layered structure, in a plan view. The core 6 is composed of a left-hand core profile 13, a right-hand core profile 14 and a joining structure 15. The joining structure 15 extends in the transverse direction Y between the core profiles 13 and 14 and connects the core profiles 13 and 14 to each other. The joining structure 15 forms a central side wall for the two core profiles 13 and 14. The joining structure 15 extends in the binding portion 2 of the sliding board. It can extend over the entire length of the binding portion 2. FIG. 5 shows the core profiles 13 and 14 as having straight outer side lines, although this merely serves to simplify the representation. The lateral outer contour of the core profiles 13 and 14 advantageously follows the sidecut of the snow sliding board.

The core profile 13 and the core profile 14 can each directly form a side wall of the snow sliding board. If the side walls are therefore integrated into the core 6, the core 6 can extend up to the edges on the lower side of the snow sliding board, thus forming the side walls.

The core profiles 13 and 14 extend over the entire or almost the entire length of the snow sliding board, i.e. from the front end of the snow sliding board up to the rear end, respectively, as indicated by the sliding board portions 1, 2 and 3 which are indicated for comparison. The joining structure 15 can exhibit at least substantially the same length as the binding portion 2. A front core profile portion of each of the core profiles 13 and 14 protrudes beyond the joining structure 15 in the longitudinal direction X. Rear core profile portions of each of the core profiles 13 and 14 also protrude backwards beyond the joining structure 15 counter to the longitudinal direction X. In the example embodiment, the two front core profile portions have at least substantially the same length as the front sliding board portion 1, and the rear core profile portions each have at least substantially the same length as the rear sliding board portion 3. The longitudinal portions of the core 6 are therefore referred to below as the front core portion 1, the core joining portion 2 and the rear core portion 3.

The joining structure 15 can be molded separately from the core profiles 13 and 14 and fixedly joined to the core profiles 13 and 14. The joining connection between the joining structure 15 and the core profile 13 and between the joining structure 15 and the core profile 14 can each in particular be or at least comprise an adhesive connection. The joining structure 15 can then be glued to the left-hand core profile 13 over an area on its left-hand side and glued to the right-hand core profile 14 over an area on its right-hand side. Once an adhesive has been applied, the core profiles 13 and 14 are expediently pressed against the joining structure 15 on the left and right, until the adhesive connection is established. Instead of or preferably in addition to a material-fit connection, for example an adhesive connection, the joining structure 15 can be connected to the left-hand core profile 13 and/or right-hand core profile 14 in a positive fit. In order to establish a positive fit, one or more engaging elements can be molded on each of the left-hand side and right-hand side of the joining structure 15, and one or more complementary engaging elements which accordingly co-operate with the engaging elements can be molded on the inner sides of the core profiles 13 and 14.

The core 6 which is formed by joining the core profiles 13 and 14 and the joining structure 15 is at least substantially symmetrical in relation to a central longitudinal axis L which extends in the longitudinal direction X. The core profiles 13 and 14 are not “profiles” in the narrower sense, since the cross-section of the core profile 13 and the cross-section of the core profile 14 change from a longitudinal center of the joining structure 15 in and/or counter to the longitudinal direction X, i.e. towards the front end and/or towards the rear end, wherein the cross-section of the respective core profile 13 and 14 can change in the transverse direction Y and/or in the vertical direction Z.

An intermediate space 17 which remains between the core profiles 13 and 14 in the front core profile section 1 extends from a front end of the joining structure 15 up to the front end of the core 6 and terminates openly at the front end. In the example embodiment, a rear intermediate space 18 which remains between the core profiles 13 and 14 extends from the joining structure 15 up to the rear end of the snow sliding board and terminates openly at the rear end. The intermediate space 17 and/or the intermediate space 18 can each remain devoid of material in the layered structure of the snow sliding board or can instead be filled with a material which advantageously exhibits a lower Shore hardness than the material of the joining structure 15.

The front intermediate space 17 can widen in the transverse direction Y from the joining structure 15 towards the front end of the snow sliding board. The intermediate space 17 can be elongated, for example slot-shaped, in the longitudinal direction X. The intermediate space 17 can widen significantly in its front end region, wherein the width A of the intermediate space 17, which corresponds to the distance A between the core profiles 13 and 14 as measured in the transverse direction Y, can be more than half or more than two thirds of the overall width of the core 6 in the front end region. The intermediate space 17 can widen forwards, for example in a delta shape or a U shape, in its front end region.

The rear intermediate space 18 can widen from the joining structure 15 towards the rear end of the snow sliding board, wherein the intermediate space 18 is advantageously elongated, for example slot-shaped, in the longitudinal direction X. In its rear end region, it can exhibit a widening which is enlarged in the transverse direction Y in a comparable way to the widening in the front end region. The width A of the front intermediate space 17 and/or rear intermediate space 18 as measured in the transverse direction Y therefore varies as a function of the axial position at which the width A is measured, i.e. it is a function A (x) of the longitudinal position.

The cross-section of the core profiles 13 and 14 changes over the length of the core profiles 13 and 14, not only in the transverse direction Y but also in the vertical direction Z. In the core joining portion 2, i.e. in the length region of the axial overlap with the joining structure 15, the core profiles 13 and 14 each exhibit a maximum height or thickness H as measured in the vertical direction Z. The joining structure 15 can exhibit the same thickness H as the core profiles 13 and 14 over its entire length overlapping with the core profiles 13 and 14. The core joining portion 2 as a whole can be at least substantially plate-shaped. In the front sliding board region 1 and/or in the rear sliding board region 3, the core profiles 13 and 14 advantageously exhibit a lower thickness H than in the overlap with the joining structure 15. The transition from the overlap region into the comparatively thinner or flatter front core portion 1 and/or the transition from the overlap region into the relatively thinner or flatter rear core portion 3 is advantageously continuous. Preferably, the transition does not occur abruptly, but rather gradually over a certain longitudinal extent. The outer surface of the snow sliding board at least substantially follows the contour of the core 6 on the upper side, i.e. it exhibits a front sliding board portion 1 and/or rear sliding board portion 3 which is flatter than the binding portion 2.

The variation in the cross-section of the core 6 in relation to the vertical direction Z can be seen from the cross-sections shown in FIGS. 6 to 8. FIG. 6 shows the core 6 in the cross-section VI-VI in FIG. 5, i.e. in the rear core portion 3. FIG. 7 shows the cross-section VII-VII of the core joining portion 2. FIG. 8 shows the cross-section VIII-VIII in the front core portion 1. A1, A2 and A3 are the distances between the core profiles 13 and 14 in the respective cross-section, while B1, B2 and B3 denote the width of the core 6 in the respective cross-section. The heights or thicknesses H1, H2 and H3 in the respective cross-section are also indicated.

With regard to the distances between the inner sides of the core profiles 13 and 14 which face opposite each other, the relations A1>A2 and/or A3>A2 advantageously hold, wherein the distance or width A1 is advantageously equal to or greater than the distance A2, as measured at any longitudinal position in the core joining portion 2, over the entire length of the front core portion 1 and/or wherein the distance A3 as measured at any longitudinal position in the rear core portion 3 is equal to or greater than the distance A2 as measured at any point in the core joining portion 2. The core profiles 13 and 14 advantageously exhibit the smallest distance from each other in the core portion 2, i.e. in the overlap with the joining structure 15.

With regard to the width B (X), B1>B2 and/or B3>B2 holds in advantageous embodiments, wherein in this case again, the respective relation preferably holds for any axial position in the front core portion 1, core joining portion 2 and rear core portion 3.

In relation to the thickness H (X) as measured in the vertical direction Z, H1<H2 and/or H3<H2 can advantageously hold, wherein in advantageous embodiments, the respective relation with regard to the thickness H (X) also holds in relation to any axial position in the front core portion 1, core joining portion 2 and rear core portion 3.

FIG. 6 indicates that the rear intermediate space 18 can be filled with material. FIG. 8 indicates that the front intermediate space 17 can be filled with material. If the front intermediate space 17 and/or the rear intermediate space 18 is/are filled with material, the material is advantageously one which exhibits a lower Shore hardness than the material of the joining structure 15. A plastic having a hardness in the Shore D range of more than 50D or more than 55D or more than 60D is advantageously used for the joining structure 15. A highly impact-resistant plastic, such as an acrylonitrile butadiene styrene (ABS) copolymer, is for example suitable as a material for the joining structure 15. If one or both of the intermediate spaces 17 and 18 is/are filled with material, the material is advantageously a plastic having a lower hardness, preferably a hardness in the Shore A range. In advantageous embodiments, however, the front intermediate space 17 and/or the rear intermediate space 18 remain devoid of material.

FIG. 7 indicates that the joining structure 15 can be provided with one or more engaging elements 16 on the left and right, respectively, and that the core profiles 13 and 14 can each be provided with one or more complementary engaging elements. In the example embodiment, the joining structure 15 comprises an outwardly projecting engaging element 16 on both sides, and the core profiles 13 and 14 each comprise an accordingly adapted recess on their inner side for a positive-fit engagement. In the example embodiment, the engaging elements 16 of the joining structure 15 are a left-side and right-side longitudinal rib. The core profiles 13 and 14 correspondingly each comprise a longitudinal groove as a complementary engaging element. The relationship can also be reversed. As a result, a tongue-and-groove connection is obtained which advantageously supplements the material-fit connection.

The strand geometry of the composite layer can advantageously be adapted to the division of the core 6 into a left-hand core profile 13 and a right-hand core profile 14. The first strands 11 can then for example span the front intermediate space 17 in a plan view in the front sliding board portion 1, in order to transmit transverse forces between the core profiles 13 and 14 in the front sliding board portion 1 but still allow relative movements between the core profiles 13 and 14 to a certain extent. This can reduce the torsional stiffness in the front sliding board portion 1 as compared to a continuous core. At the same time, vibrations can be damped due to a damping effect of the strands 11 and 12, which are preferably made of fibers, in particular in embodiments in which natural fibers are also or exclusively used. In advantageous embodiments, the first strands 11 overlap with both the left-hand core profile 13 and the right-hand core profile 14. They can in particular extend up to the outer side of the respective core profile 13 and 14. If a composite layer comprising a substrate layer and one or more strands corresponding for example to the substrate layer 8 and the strands 11 and 12 is likewise arranged in the rear sliding board portion 3, the same also holds for the rear sliding board portion 3.

The composite layer in the front sliding board portion 1, and the composite layer in the rear sliding board portion 3 if one is likewise provided, can advantageously (each) be tailored to the geometry and/or the mechanical characteristics, in particular flexural stiffness, of the core profiles 13 and 14 in the respective sliding board portion 1 and/or 3, in terms of their strand material and/or strand profile and/or strand cross-section, in order to distribute the forces and/or moments between the core profiles 13 and 14 in the front sliding board portion 1 and/or in the rear sliding board portion 3 and/or to damp vibrations.

### REFERENCE SIGNS

1 front sliding board portion, front core portion
2 binding portion, core joining portion
3 rear sliding board portion, rear core portion
4 sliding layer
5 lower laminate
6 core
7 upper laminate
8 substrate layer
9 covering layer
10 —
11 strand
12 strand
13 left-hand core profile
14 right-hand core profile
15 joining structure, central side wall
16 engaging element
17 front intermediate space
18 rear intermediate space
A distance
B width
D strand thickness
H core thickness
d degree of protrusion of strand
W peak height
X longitudinal direction
Y transverse direction
Z vertical direction

1. A snow sliding board comprising:
(a) multiple material layers arranged one above the other, including a substrate layer and a polymeric covering layer material, for example a synthetic resin, which covers the substrate layer on an upper side and forms a free surface on an upper side of the snow sliding board; and
(b) a strand geometry comprising one or more strands of strand material,
(c) wherein the respective strand is fixedly connected to the substrate layer in order to form a composite layer and extends above the substrate layer, and
(d) wherein the respective strand is raised protruding upwards and can be optically and haptically perceived as a raised structure on the upper side of the snow sliding board.

2. The snow sliding board according to claim 1, wherein the respective strand exhibits a thickness as measured in a vertical direction of the snow sliding board and produces a peak of height on the upper side of the snow sliding board, and wherein w>0.3×D or w≥0.5×D.

3. The snow sliding board according to claim 1, wherein the respective strand exhibits a thickness as measured in a vertical direction of the snow sliding board and is raised protruding upwards beyond the substrate layer by a degree of protrusion, and wherein d>0.3×D or d≥0.5×D or d≥0.7×D.

4. The snow sliding board according to claim 1, wherein the respective strand is fixed to the substrate layer at multiple points, preferably by means of a thread.

5. The snow sliding board according to claim 1, wherein at least a lower cross-sectional region of the respective strand, preferably the respective strand as a whole, is embedded, at least in portions, in the polymeric covering layer material.

6. The snow sliding board according to claim 1, wherein the polymeric covering layer material covers the respective strand on the latter's upper side.

7. The snow sliding board according to claim 1, wherein the polymeric covering layer material covers the respective strand at least in portions, such that the free surface formed by the covering layer material is undulating, at least in regions, in cross-sections and/or longitudinal sections of the snow sliding board.

8. The snow sliding board according to claim 1, wherein the covering layer material covers the respective strand at least in portions, and a thickness of the polymeric covering layer material on an upper side of the respective strand is smaller than in a region of the covering layer material next to the respective strand.

9. The snow sliding board according to claim 1, wherein the composite layer extends in a front sliding board portion, advantageously in a paddle region of a ski.

10. The snow sliding board according to claim 1, wherein the composite layer or another composite layer extends in a rear sliding board portion.

11. The snow sliding board according to claim 1, wherein the composite layer extends counter to the longitudinal direction in the front sliding board portion or in the longitudinal direction in the rear sliding board portion up to at most a binding portion.

12. The snow sliding board according to claim 1, wherein the composite layer extends counter to the longitudinal direction from the front sliding board portion up to and into the binding portion or rear sliding board portion, wherein the respective strand is preferably pressed in and/or pressed flat in the binding portion, such that the binding portion exhibits an at least substantially non-undulating surface on the upper side.

13. The snow sliding board according to claim 1, wherein the respective strand is connected to the substrate layer by means of a laying and stitching method.

14. The snow sliding board according to claim 1, wherein the strand geometry exhibits one or more crossing points at which the one or more strands cross in a plan view onto the upper side of the snow sliding board.

15. The snow sliding board according to claim 1, wherein the polymeric covering layer material is a synthetic resin.

16. The snow sliding board according to claim 1, wherein the substrate layer is a textile fabric.

17. The snow sliding board according to claim 1, wherein the substrate layer is a knitted fabric, for example a warp-knitted fabric, or a woven fabric, scrim or fleece.

18. The snow sliding board according to claim 1, wherein the respective strand is a roving or yarn or rope made of plastic fibers and/or filaments and/or ceramic fibers and/or filaments and/or mineral fibers and/or filaments and/or natural fibers and/or filaments.

19. The snow sliding board according to claim 1, wherein the respective strand is a roving or yarn or rope made of carbon fibers and/or filaments and/or bast fibers and/or filaments, for example flax fibers and/or filaments.

20. The snow sliding board according to claim 1, wherein the strand structure comprises one or more first strands made of a first material, for example carbon fibers and/or filaments and/or flax fibers and/or filaments, and one or more other, second strands made of a different, second material, for example natural fibers and/or filaments.

21. The snow sliding board according to claim 1, wherein
the strand structure comprises a first strand and a second strand,
the first strand and/or the second strand extend(s) above the substrate layer at least in portions and is/are fixedly connected to the substrate layer,
the first strand and/or the second strand is/are raised protruding upwards at least in portions, such that the first strand and/or the second strand can be optically and haptically perceived as a raised structure on the upper side of the snow sliding board.

22. The snow sliding board according to claim 21, wherein the first strand exhibits a different cross-section as measured in the vertical direction of the snow sliding board, for example a different thickness as measured in the vertical direction and/or a different outer contour and/or a different cross-sectional area, than the second strand.

23. The snow sliding board according to claim 21, wherein the first strand crosses the second strand.

24. The snow sliding board according to claim 21, wherein the first strand and/or the second strand extends or each extend in one or more loops.

25. The snow sliding board according to claim 24, wherein the first strand and/or the second strand crosses itself.

26. The snow sliding board according to claim 21, wherein the second strand has a greater tensile strength than the first strand.

27. The snow sliding board according to claim 21, wherein the first strand comprises natural fibers and/or filaments, for example made of flax or hemp or sisal or kenaf, and the second strand comprises carbon fibers and/or filaments.

28. The snow sliding board according to claim 1, wherein the snow sliding board comprises multiple first strands and/or multiple second strands.

29. A snow sliding board comprising:
(a) a front sliding board portion which comprises a front end of the snow sliding board, a rear sliding board portion which comprises a rear end of the snow sliding board, and a binding portion which extends in a longitudinal direction from the rear sliding board portion up to the front sliding board portion in a plan view onto the snow sliding board, for arranging a sliding board binding;
(b) a sliding layer on a lower side of the snow sliding board; and
(c) a multi-part core arranged between the sliding layer and the upper covering layer and comprising a left-hand core profile and a right-hand core profile which extend in the longitudinal direction through the binding portion into the front sliding board portion and into the rear sliding board portion and exhibit a distance from each other as measured in the transverse direction, at least in the front sliding board portion and/or in the rear sliding board portion.

30. The snow sliding board according to claim 29, wherein the strand geometry couples the left-hand core profile and the right-hand core profile in relation to transverse forces and/or longitudinal forces.

31. The snow sliding board according to any one of the immediately preceding two claims claim 29, wherein the strand geometry comprises one or more strands or strand portions which spans or which each span a front intermediate space which remains between the core profiles in the front sliding board portion and/or a rear intermediate space which remains between the core profiles in the rear sliding board portion.

32. The snow sliding board according to claim 31, comprising a joining structure made of a joining material which extends between the core profiles, is joined to the core profiles and fixedly connects the core profiles in the binding portion.

33. The snow sliding board according to claim 32, wherein the joining structure is arranged between inner sides of the core profiles which face each other in the transverse direction.

34. The snow sliding board according to claim 32, wherein the joining structure terminates at the front sliding board portion and at the rear sliding board portion, and the binding portion is preferably shorter in the longitudinal direction than the front sliding board portion and/or preferably shorter in the longitudinal direction than the rear sliding board portion.
